(19) United States
(12) Patent Application Publication
(10) Pub. No.: US 2023/0301318 A1
(43) Pub. Date: Sep. 28, 2023

(54) COLLOIDAL COMPOSITIONS OF MICROCRYSTALLINE CELLULOSE AND ALGINATE, THEIR PREPARATION AND PRODUCTS OBTAINED THEREFROM

(71) Applicant: DUPONT NUTRITION USA, INC., Wilmington, DE (US)

(72) Inventors: HONG YANG, NEWARK, DE (US); JOYCE MEI YAN TOH, LANGHORNE, PA (US); JEREMY ONDOV, NEW YORK, NY (US); AARON VENABLES, YARDLEY, PA (US)

(21) Appl. No.: 18/063,345

(22) Filed: Dec. 8, 2022

Related U.S. Application Data
(63) Continuation of application No. 16/013,136, filed on Jun. 20, 2018, now abandoned.
(60) Provisional application No. 62/555,891, filed on Sep. 8, 2017.

(51) Int. Cl. A23C 9/154; C08L 5/04; A23G 1/56; A23L 29/262; A23L 29/256; A23L 2/52; C08L 1/04

(52) U.S. Cl. CPC A23C 9/1544; C08L 5/04; A23G 1/56; A23L 29/262; A23L 29/256; A23L 2/52; C08L 1/04; A23V 2002/00; C08L 2205/03

(57) ABSTRACT

The present invention is directed colloidal microcrystalline compositions, particularly for suspending particles in low viscosity fluids, produced by co-attrition of a mixture of microcrystalline cellulose and a first polysaccharide in the presence of acidic attrition aid and blending a second polysaccharide; their preparation; and, products made therewith.

### FIELD OF THE INVENTION

The present invention is directed to colloidal microcrystalline compositions, particularly for suspending particles in low viscosity fluids, produced by combining a co-attrited mixture of microcrystalline cellulose and a polysaccharide in the presence of acidic attrition aid and a second polysaccharide; their preparation; and, products made therewith.

### BACKGROUND OF THE INVENTION

Microcrystalline cellulose, also known and referred to herein as “MCC”, is hydrolyzed cellulose. MCC powders and gels are commonly used in the food industry to enhance the properties or attributes of a final food product. For example, MCC has been used as a binder and stabilizer in a wide variety of consumable products such as food applications, including in beverages, as a gelling agent, a thickener, a fat substitute, and/or non-caloric filler, and as a suspension stabilizer and/or texturizer. MCC has also been used as a binder and disintegrant in pharmaceutical tablets, as a suspending agent in liquid pharmaceutical formulations, and as a binder, disintegrant, and processing aid, in industrial applications, in household products such as detergents and/or bleach tablets, in agricultural formulations, and in personal care products such as dentifrices and cosmetics. An important application for colloidal MCC is stabilization of suspensions, e.g., suspensions of solid particles in low viscosity liquids; and, more specifically, suspension of solids in milk, e.g., cocoa particles in chocolate milk.

MCC may be modified for the above-mentioned uses by subjecting hydrolyzed MCC aggregated crystallites, in the form of a high solids aqueous mixture, commonly known as “wetcake”, to an attrition process, e.g., extrusion, that substantially subdivides the aggregated cellulose crystallites into more finely divided crystallite particles. To prevent hornification, a protective hydrocolloid may be added before, during, or following attrition, but before drying. The protective hydrocolloid, wholly or partially, screens out the hydrogen bonds or other attractive forces between the smaller sized particles to provide a readily dispersible powder. Colloidal MCC will typically form stable suspensions with little to no settling of the dispersed solids. Carboxymethyl cellulose is a common hydrocolloid used for these purposes (see for example U.S. Pat. No. 3,539,365 (Durand et al.) and the colloidal MCC products sold under the brand names AVICEL® and GELSTAR® by FMC Corporation. Many other hydrocolloids have been tried to co-process with MCC, such as starch, in U.S. Pat. App. 2011/0151097 (Tuason et al.)

One of the disadvantages of colloidal MCC having carboxymethyl cellulose of a viscosity of at least 100 cP and a degree of substitution of at least 0.95 is that they may be too ‘slippery’ to provide effective co-attrition of wetcake. Less than satisfactory attrition of the MCC particles can have a deleterious effect on the functionality of a MCC stabilizer. As a result, attempts have been made to solve this problem by using an attrition aid, e.g., a salt of multivalent ions, to increase friction among the particles in the wetcake to make attrition more effective. For example, see: U.S. Pat. Nos. 7,879,382 and 7,462,232. Other approaches have been taken to improve attrition of MCC/hydrocolloid compositions, for example, see: US 2005/0233046; US 2011/0151097; and WO 2010/136157.

Because of the nature of it's processing, CMC has recently come under attack for not being a “clean label” component, although still considered safe by regulatory authorities. As such, attempts have been made to replace the CMC with polysaccharides from various plant sources. This has proved challenging, however since each polysaccharide has its own unique structure and it has been difficult to predict their functionality. Many polysaccharides have not been found effective for making dispersion stable MCCs at least partially due to a lack of transfer of sufficient mechanical force to the MCC aggregates and polysaccharides during attrition. One attempt to mitigate the problem has been to use multivalent salts such as calcium chloride (see for example 7,462,232 B2, to Tuason et al). However, under the specific conditions described by Tuason (cool/ambient dispersion of Avicel® AC4125 to reduce the gelling potential due to interaction of guluronate groups in alginate with calcium ions in the milk) a sequestrant was needed.

The co-attrited colloidal composition can be dispersed easily in food, beverage, pharmaceutical, industrial, and many other products; including, cool/ambient milk products, e.g., chocolate milk, without the use of sequestrant.

There is a need therefore to devise a colloidal MCC composition useful for the stabilization of low viscosity liquids that may be effectively attrited without the addition of multivalent ions and avoiding the presence of CMC.

Applicants have met the stated need, by providing a co-attrited colloidal composition that can be effectively attrited without carboxymethyl cellulose and/or multi-valent ions; and, can be dispersed easily in consumable products such as food, beverage, pharmaceutical, industrial, and many other products; including, cool/ambient milk products, e.g., chocolate milk, without the use of sequestrant.

### SUMMARY OF THE INVENTION

The invention provides a stabilizer composition comprised of MCC blended with a first and second polysaccharide where the MCC is at least partially coated with the polysaccharides of the invention. The stabilizer composition is prepared by first co-attriting the mixture of the MCC and the first polysaccharide to form a colloidal mixture and then blending this mixture with a second polysaccharide. The stabilizer compositions of the invention are useful in the stabilization of consumable products, including food and beverages.

Accordingly in one aspect the invention provides a stabilizer composition comprising:
(i) microcrystalline cellulose;
(ii) a first polysaccharide; and
(iii) a second polysaccharide;
Wherein the microcrystalline cellulose and the first polysaccharide form a colloidal mixture; and
Wherein the second polysaccharide is present in a concentration of from about 3 to about 20 wt % based on the solid weight of the colloidal mixture of the microcrystalline cellulose and the first polysaccharide.

Optionally the stabilizer composition may also include an attrition agent, typically an acid. Preferred polysaccharides of the invention are various alginates from various species of the brown seaweeds, including those with at least 50% mannuronic acid residues.

In another aspect the invention provides a process for the production of a stabilizer composition comprising microcrystalline cellulose and a first and second polysaccharide comprising the steps of: a) co-attriting microcrystalline cellulose with a first polysaccharide to obtain a colloidal co-attrited mixture of MCC and the first polysaccharide; and b) blending the colloidal mixture of step (a) with a second polysaccharide wherein the second polysaccharide comprises from about 3 to about 20 wt % of the colloidal mixture obtained in step (a). Additionally the invention provides consumable products, such as foods, nutraceuticals, pharmaceuticals and cosmetics comprising the stabilizer composition of the invention. Ideally such consumable products will attain both Suspension and Dispersion Stability (as defined herein).

### DETAILED DESCRIPTION OF THE INVENTION

Unless otherwise specified all references cited herein are incorporated by reference in their entirety.

The following definitions may be used for the interpretation of the claims and specification:

As used herein, the terms “comprises,” “comprising,” “includes,” “including,” “has,” “having,” “contains” or “containing,” or any other variation thereof, are intended to cover a non exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the specification and the claims.

As used herein, the term “about” modifying the quantity of an ingredient or reactant of the invention employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities. In one embodiment, the term “about” means within 10% of the reported numerical value, preferably within 5% of the reported numerical value.

The term “stabilizer composition” will mean a composition of the invention useful in stabilizing consumable products comprising MCC particles and both a first and second polysaccharide where the MCC particles are at least partially coated with the polysaccharides.

The term “D₅₀” as used in relation to particle size distribution denotes the diameter of the particle that 50% of a sample's volume is smaller than, and 50% of a sample's volume is larger than.

As used herein, “aggregated MCC” means MCC prior to attrition; “attrited MCC” means MCC after attrition; and, “colloidal MCC” means MCC, after attrition in which the D₅₀ of at least 19% by volume of the MCC particles is about 0.110 microns as measured by the static light scattering.

The term “attrition aid” or “attrition agent” will be used interchangeably and means a reagent added to an aggregated MCC composition that facilitates attrition, particularly extrusion.

The term Dispersion Stability or Dispersion Stable, as used herein, means that the coated MCC particles themselves disperse uniformly in liquids, e.g., an aqueous medium, without vigorous agitation forming a suspension having a homogenous appearance without significant separating, aggregating or settling of the particles.

The term Suspension Stability, as used herein, means that when the coated MCC particles are dispersed in a liquid, e.g., aqueous medium, milk, etc., containing insoluble components other than the MCC particles, e.g., cocoa, calcium, etc., those particles are effectively suspended forming a stabilized suspension having a homogenous appearance without significant separating, aggregating, or settling of the insoluble particles.

The term “polysaccharide” means a carbohydrate containing more than three monosaccharide units per molecule, the units being attached to each other in the manner of acetals, and therefore capable of hydrolysis by acids or enzymes to monosaccharides. Preferred polysaccharides of the invention are those that contain acidic residues.

The terms “attrited” and “attrition” are used interchangeably to mean a process that effectively reduces the size of at least some if not all of the particles to a colloidal size.

The term “co-attrition” refers to application of high shear forces to an admixture of the MCC and at least one polysaccharide. Suitable attrition conditions may be obtained, for example, by co-extruding, milling, or kneading.

The term “consumable product” means a food, beverage, nutraceutical or pharmaceutical product that is formulated for human or animal consumption.

The present invention comprises a stabilizer composition comprising microcrystalline cellulose (MCC) in combination with a first and second polysaccharide. The polysaccharides of the composition may be the same or different. Additionally the second polysaccharide will generally comprise from about 3 to about 20 wt % of the colloidal composition of the MCC and the first polysaccharide. Preferred polysaccharides of the invention are various alginates from various species of the brown seaweeds.

Microcrystalline Cellulose

The present invention makes use of hydrolyzed microcrystalline cellulose. Microcrystalline cellulose (MCC) is a white, odorless, tasteless, relatively free flowing, crystalline powder that is virtually free from organic and inorganic contaminants. It is a purified, partially depolymerized cellulose obtained by subjecting alpha cellulose obtained as a pulp from fibrous plant material to hydrolytic degradation typically with mineral acids. It is a highly crystalline particulate cellulose consisting primarily of crystalline aggregates which are obtained by removing amorphous regions (or paracrystalline regions) of a cellulosic fibril. MCC is used in a variety of applications including foods, nutraceuticals, pharmaceuticals and cosmetics.

Any microcrystalline cellulose may be employed in the compositions of the present invention. Suitable feedstocks include, for example, wood pulp such as bleached sulfite and sulfate pulps, corn husks, bagasse, straw, cotton, cotton linters, flax, kemp, ramie, fermented cellulose, etc. Microcrystalline cellulose may be produced by treating a source of cellulose, preferably alpha cellulose in the form of pulp from fibrous plant materials, with a mineral acid, preferably hydrochloric acid. The acid selectively attacks the less ordered regions of the cellulose polymer chain thereby exposing and freeing the crystalline sites which form crystallite aggregates which constitute the microcrystalline cellulose. These are then separated from the reaction mixture, and washed to remove degraded by-products. The resulting wet mass, generally containing 40 to 75 percent moisture, is referred to in the art by several names, including hydrolyzed cellulose, hydrolyzed cellulose wetcake, level-off DP cellulose, microcrystalline cellulose wetcake or simply wetcake. Preferably, the aggregated MCC is acid hydrolyzed and 25-60% wt. in water.

When the wetcake is dried and freed of water the resulting product, microcrystalline cellulose, is a white, odorless, tasteless, relatively free-flowing powder, insoluble in water, organic solvents, dilute alkalis and acids. For a description of microcrystalline cellulose and its manufacture see U.S. Pat. No. 2,978,446. The patent describes its use as a pharmaceutical excipient, particularly as a binder, disintegrant, flow aid, and/or filler for preparation of compressed pharmaceutical tablets.

Polysaccharides

In one aspect of the invention the hydrolyzed MCC is coattrited with at least one polysaccharide. Polysaccharides useful in this invention increase energy transfer to a wetcake in the presence of acid, e.g., at pHs 4.5 or less. Preferred in the present invention are those polysaccharides containing acidic sugar residues such as for example, galacturonic acid, glucuronic acid, mannuronic acid and/or guluronic acid residues. It is particularly preferred where those residues reside on a main polymer chain in the polysaccharide. The polysaccharides of the invention may be isolated from a multiplicity of plant exudates as from for example gum arabic, gum ghatti, gum karaya, gum tragacanth; plant seeds such as starches, locust bean gum, guar gum, psyllium seed gum, quince seed gum; plant roots such as konjac; seaweed polysaccharides (e.g. agar, carrageenan, furcellaran, alginate and derivatives thereof such as propylene glycol alginate and monovalent salts of alginates), microbial and/or fermentation products such as dextran, xanthan gum, gellan, and combinations thereof.

Preferred herein are alginate, karaya. Optionally the polysaccharide may be carboxymethyl cellulose. Particularly preferred is alginate which is a salt of alginic acid and a linear copolymer with homopolymeric blocks of mannuronic acids and guluronic acid residues.

Polysaccharides useful in this invention increase energy transfer to a wetcake in the presence of acid, e.g., at pHs 4.5 or less. The polysaccharides include acidic groups, preferably, galacturonic acid, glucuronic acid, mannuronic acid and/or guluronic acid residues, positioned in their main polymer chain, e.g., alginate, karaya where optionally the polysaccharide may be carboxymethyl cellulose. This polysaccharide is selected to be compatible with the intended product requirements, e.g., generally recognized as safe for ingestible products.

Use of certain polysaccharides in the colloidal stabilizer mixture above a certain level in certain food products can result in an undesirable thickening of the product. To reduce the thickening, it can be effective to mix the colloidal MCC mixture with a second polysaccharide prior to combining the stabilizer with a food product.

For example, use of a colloidal MCC mixture described herein as a stabilizer above the level of about 0.30 wt %, or above about 0.35 wt %, or above about 0.40 wt % in a food product can result in an undesirable thickening of the food product. Thickening can be avoided or reduced by mixing the co-attrited MCC/polysaccharide stabilizer with from about 3 to about 20 wt % of a second polysaccharide. Alternatively the stabilizer can be mixed with from about 4 to about 15 wt %, or from about 5 to about 10 wt % of a second polysaccharide.

Use of the stabilizers described herein can provide stability in a food product comprising the stabilizer against substantial viscosity increase, phase separation (for example, sedimentation, marbling, dusting) without detrimental effect on other properties such as flow properties of the components. Use of the stabilizers described herein can improve stability of the food composition over at least a 24-hr observation period, or at least a 7-day observation period, or at least a 30-day observation period, or at least 3-month observation period.

The second polysaccharide can be the same as or different from the first polysaccharide. It can be preferred that the second polysaccharide is an alginate. Alginate is a family of linear binary copolymers of (1→4)-linked β-D-mannuronic acid (M) and α-L-guluronic acid (G) residues of widely varying composition and sequence. Work on the sequential structure of alginates reveals many fractions of widely differing composition: homopolymeric molecules of guluronic and mannuronic acid, nearly equal proportions of both monomers containing a large number of MG or GM dimer residues, just name a few main fractions. Therefore, alginate is a true block copolymer composed of homopolymeric regions of M and G, termed M- and G-blocks, respectively, and interspersed with regions of alternating structure, MG- or GM-blocks. Alginate with high proportion and continuous G-blocks can cause a higher gelling potential in the presence of multivalent ions, such as calcium ions present in the milk systems. Conversely, an alginate with high proportion and continuous M-blocks yields a lower gelling potential.

Commercial alginates are produced mainly from Laminaria hyperborea, Macrocystis pyrifera, Laminaria digitata, Ascophyllum nodosum, Laminaria japonica, Eclonia maxima, Lessonia nigrescens, and Durvillea Antarctica. In an industrial setting, gel strength under defined conditions is typically measured to estimate M-block/G-block ratio besides viscosity and pH on the specification sheet of alginate products.

Additional polysaccharides useful in the present invention include carrageenans (iota, lambda, kappa, kappa-2, mu, nu, theta, or mixtures thereof), alginate, pectins (including high methoxyl, low methoxyl pectins, and acetylated pectins (such as beet pectin)), xanthan gums, agar gums, wellan gums, gellan gums and mixtures thereof. Semi-refined carrageenans are also useful in the present invention (these are less purified forms of the carrageenans that may contain some of the structural components of the seaweed such as cellulose)

It is preferred that the second polysaccharide is an alginate comprising at least 50% mannuronic acid residues (M). It can also be preferred that the ratio of M to G in an alginate suitable for use herein be greater than about 1:1, or alternatively greater than about 1.5:1, or greater than 1.7:1 (M:G).

Alginates suitable for use herein can comprise significant portions of continuous M-block polymers, or can comprise significant portions of alternating block (MG or GM) regions. It can be preferred to exclude alginates having significant portions of continuous G-block polymers.

Attrition Aids

The present invention uses an attrition aid, typically an acid, in the co-attrition process. Suitable acids include but are not limited to formic acid, acetic acid, propionic acid, butyric acid, valeric acid, caproic acid, oxalic acid, lactic acid, malic acid, citric acid, tartaric acid, benzoic acid, carbonic acid, hydrochloric acid, nitric acid, phosphoric acid, sulfuric acid, boric acid, hydrofluoric acid, and hydrobromic acid. Preferred herein are organic and inorganic acids. Such acids capable of reducing the pH of wetcake to 4.5 or less and otherwise compatible with the intended product, e.g., generally recognized as safe for ingestible products. Preferred acids include: malic acid, citric acid, tartaric acid, HCl, nitric acid, phosphoric acid; and, more preferred are citric acid, HCl, nitric acid, phosphoric acid, and mixtures thereof.

Attrition Methods The hydrolyzed MCC and polysaccharide are typically co-attrited in the presence of the acid to form the co-attrited composition wherein the MCC particles are at least partially coated by the polysaccharide. Attrition methods are common and well known in the art (see for example US Patent Application 2013/0090391 and U.S. Pat. No. 9,828,493 which are hereby incorporated by reference. The methods include preparing an aggregate microcrystalline cellulose of between about 25% and 60% wt. solids; further including a polysaccharide, and an attrition agent comprising an acid thereof; wherein the D₅₀ of at least 19% by volume of the MCC particles is about 0.110 microns. The composition is 40-91.99% wt. MCC, 8-50% wt. the first polysaccharide and 0.01-10% by wt. attrition agent.

Attrition may be accomplished by extrusion, for example or with other mechanical devices including, e.g., refiners, planetary mixers, colloidal mills, beat mills, kneaders, and grinders that can provide effective shearing force. However, as particle size is reduced, the individual particles tend to agglomerate or hornify upon drying, a result that is undesirable because it impedes dispersion of the individual particles. Consequently In some embodiments, the D₅₀ of at least about 20%, or 35% or 30% or 35% of 40% or 45% of 50% of 55% or 60% or 65% or 70% by volume of the MCC particles is about 0.110 microns, or may be from about 0.110 microns to about 0.70 microns or from about 0.110 microns to about 0.65 microns or from about 0.110 microns to about 0.50 microns.

The extrudate can be dried or be dispersed in water to form a slurry. The slurry can be homogenized and dried, preferably spray dried. Drying processes other than spray drying include, for example, fluidized bed drying, drum drying, bulk drying, and flash drying. Dry particles formed from the spray drying can be reconstituted in a desired aqueous medium or solution to form the compositions, edible food products, pharmaceutical applications, and industrial applications described herein.

Effectiveness of the attrition can be assessed through measuring the viscosity of the mixture of MCC and polysaccharide through the attrition as compared to the viscosity of the mixture of MCC and polysaccharide without through the attrition. During an attrition, strong mechanical shear forces not only break down aggregated MCC particles but also introduce a mixing action to spread polysaccharide molecules around the reduced MCC particles. Furthermore, water molecules in between of MCC particles and polysaccharide are squeezed out to bring MCC particles and polysaccharide into a close contact. Eventually, certain portion on the surface of MCC particles is forced to bond certain segment of polysaccharide chains through molecular interaction force, for instance, the hydrogen bond. In such a manner, the MCC particles act as the node points of polysaccharide network, like crosslinking of polysaccharide, leading to the increase in the viscosity of the mixture of MCC particles and polysaccharide.

Therefore in one embodiment the invention provides a method for producing the stabilizer composition of the invention may comprise the steps of (a) co-attriting microcrystalline cellulose (MCC) with a first polysaccharide in the substantial absence of carboxymethyl cellulose and/or a multi-valent ion to obtain a colloidal co-attrited mixture of MCC and the first polysaccharide; (b) blending the colloidal mixture of step (a) with from about 3 to about 20 wt %, based on the solid weight of the colloidal mixture obtained in step (a), of a second polysaccharide.

In another embodiment the invention provides a method for producing the stabilizer composition may comprise the steps of (a) co-attriting microcrystalline cellulose (MCC) with a first polysaccharide in the substantial absence of carboxymethyl cellulose and/or a multi-valent ion to obtain a colloidal co-attrited mixture of MCC and the first polysaccharide; (b) blending the colloidal mixture of step (a) with from about 3 to about 20 wt %, based on the solid weight of the colloidal mixture obtained in step (a), of a second polysaccharide, wherein the first and second polysaccharide are alginates and wherein the stabilizer composition comprises from about 9% to about 68% wt % total alginate.

Mechanism of Action.

Without wishing to be bound by any particular theory or mode of action for the subject invention, it is believed that the acid reduces the solubility of the polysaccharide during attrition, which increases the transfer of mechanical energy to the wetcake, making attrition more effective so that the MCC particles are more efficiently subdivided to colloidal sizes and at least partially coated without the use of salts of multi-valent metals or carboxymethyl cellulose. The resulting colloidal MCC is easily dispersed in aqueous systems and effectively stabilizes suspensions including in an aqueous medium, e.g., cool milk.

### Preferred Compositions

In one preferred embodiment the stabilizer composition will comprise or consist essentially of (i) a colloidal mixture of microcrystalline cellulose and a first polysaccharide and (ii) from about 3 to about 20 wt % of a second polysaccharide, based on the solid weight of component (i).

In another preferred embodiment the stabilizer composition is a MCC/polysaccharide stabilizer composition comprising or consisting essentially of: (i) a colloidal mixture of microcrystalline cellulose and a first polysaccharide; and, (ii) from about 3 to about 20 wt % of alginate as a second polysaccharide, based on the solid weight of component (i); wherein the first polysaccharide is an alginate present in an amount of 8-50 wt % based on the solid weight of the colloidal mixture.

In another embodiment the stabilizer composition is an MCC/polysaccharide stabilizer composition comprising or consisting essentially of: (i) a colloidal mixture of microcrystalline cellulose and a first polysaccharide; and, (ii) from about 3 to about 20 wt % of alginate as a second polysaccharide, based on the solid weight of component (i); wherein the first polysaccharide is an alginate present in an amount of from 8-50 wt % based on the solid weight of the colloidal mixture, and the total alginate present in the stabilizer composition is from about 9% to about 68% wt %, based on the weight of the stabilizer.

Applications

The colloidal MCC compositions of the invention may be used in a variety of are suitable for a wide variety of food, pharmaceutical, nutraceutical and industrial applications including in cosmetic products, personal care products, consumer products, agricultural products, or in chemical formulations and in paint, polymer formulations.

Some examples in pharmaceutical applications include liquid suspending agents and/or emulsions for drugs; nasal sprays for drug delivery where the colloidal MCC gives increased residence and bioavailability; controlled release agents in pharmaceutical applications; and re-constitutable powders which are dry powders mixtures containing drugs which can be made into a suspension by adding water and shaking by-hand; topical drug applications, and various foams, creams, lotions for medical uses, including compositions for oral care such as toothpaste, mouthwash and the like. One particular example is a suspension of benzoyl peroxide or similar agents, which requires the stability of the colloidal MCC against oxidizing agent over time. Other examples include pharmaceutical suspensions (or re-constitutable powders) which are acidic or with high ionic strength.

Some examples in nutraceutical applications include delivery systems for various nutraceutical ingredients and dietary supplements. Examples in industrial applications include various suspensions, thickeners, which can be used in foams, creams, lotions and sun-screens for personal care applications; suspending agents, which can be used with pigments and fillers in ceramics, or used in colorants, optical brighteners, cosmetics, and oral care in products such as toothpaste, mouthwash and the like; materials such as ceramics; delivery systems for pesticides including insecticides; delivery of herbicides, fungicides, and other agricultural products, and paints, and various chemical or polymer suspensions. One particular example is an industrial wash fluid, containing oxidizing or bleach agents, which demand strong and stable suspension systems.

The stabilizer composition of the present invention may be used in a variety of food products including emulsions, beverages, sauces, soups, syrups, dressings, films, dairy and non-dairy milks and products, frozen desserts, cultured foods, bakery fillings, and bakery cream. It may also be used for the delivery of flavoring agents and coloring agents. The edible food products can additionally comprise diverse edible material and additives, including proteins, fruit or vegetable juices, fruit or vegetable pulps, fruit-flavored substances, or any combination thereof.

These food products can also include other edible ingredients such as, for example, mineral salts, protein sources, acidulants, sweeteners, buffering agents, pH modifiers, stabilizing salts, or a combination thereof. Those skilled in the art will recognize that any number of other edible components may also be added, for example, additional flavorings, colorings, preservatives, pH buffers, nutritional supplements, process aids, and the like. The additional edible ingredients can be soluble or insoluble, and, if insoluble, can be suspended in the food product. Routine adjustment of the composition is fully within the capabilities of one having skill in the art and is within the scope and intent of the present invention. These edible food products can be dry mix products (instant sauces, gravies, soups, instant cocoa drinks, etc.), low pH dairy systems (sour cream/yogurt, yogurt drinks, stabilized frozen yogurt, etc.), baked goods, and as a bulking agent in non-aqueous food systems and in low moisture food systems.

Juices suitable for incorporating the stabilizer composition include fruit juices (including but not limited to lemon juice, lime juice, and orange juice, including variations such as lemonade, limeade, or orangeade, white and red grape juices, grapefruit juice, apple juice, pear juice, cranberry juice, blueberry juice, raspberry juice, cherry juice, pineapple juice, pomegranate juice, mango juice, apricot juice or nectar, strawberry juice, and kiwi juice) and vegetable juices (including but not limited to tomato juice, carrot juice, celery juice, beet juice, parsley juice, spinach juice, and lettuce juice). The juices may be in any form, including liquid, solid, or semi-solid forms such as gels or other concentrates, ices or sorbets, or powders, and may also contain suspended solids. In another embodiment, fruit-flavored or other sweetened substances, including naturally flavored, artificially flavored, or those With Other Natural Flavors (“WONF”), may be used instead of fruit juice. Such fruit flavored substances may also be in the form of liquids, solids, or semi-solids, such as powders, gels or other concentrates, ices, or sorbets, and may also contain suspended solids.

Proteins suitable for the edible food products incorporating the stabilizer compositions include food proteins and amino acids, which can be beneficial to mammals, birds, reptiles, and fish. Food proteins include animal or plant proteins and fractions or derivatives thereof. Animal derived proteins include milk and milk derived products, such as heavy cream, light cream, whole milk, low fat milk, skim milk, fortified milk including protein fortified milk, processed milk and milk products including superheated and/or condensed, sweetened or unsweetened skin milk or whole milk, dried milk powders including whole milk powder and Nonfat Dry Milk (NFDM), casein and caseinates, whey and whey derived products such as whey concentrate, delactosed whey, demineralized whey, whey protein isolate. Egg and egg-derived proteins may also be used. Plant derived proteins include nut and nut derived proteins, sorghum, legume and legume derived proteins such as soy and soy derived products such as untreated fresh soy, fluid soy, soy concentrate, soy isolate, soy flour, and rice proteins, and all forms and fractions thereof. Food proteins may be used in any available form, including liquid, condensed, or powdered. When using a powdered protein source, however, it may be desirable to pre-hydrate the protein source prior to blending with stabilizer compositions and juice for added stability of the resulting beverage. When protein is added in conjunction with a fruit or vegetable juice, the amount used will depend upon the desired end result.

It should also be noted that the food/beverage compositions may be processed by heat treatment in any number of ways. These methods may include, but are not limited to, Low Temperature Long Time (LTLT), High Temperature Short Time (HTST), Ultra-High Temperature (UHT) and Extended Shelf Life (ESL) processes. These beverage compositions may also be retort processed, either by rotary retort or static retort processing. Some compositions, such as juice-added or natural or artificially flavored soft drinks may also be cold processed. Many of these processes may also incorporate homogenization or other high shear/high compression methods. There may also be co-dried compositions, which can be prepared in dry-mix form, and then conveniently reconstituted for consumption as needed. The resulting beverage compositions may be refrigerated and stored for a commercially acceptable period of time. In the alternative, the resulting beverages may be stored at room temperature, provided they are filled under aseptic conditions.

The described compositions can act as stabilizers are suitable for use in the beverage industry. The compositions, after drying to powder form, can be mixed with an aqueous solution to form a colloidal mixture that, in some embodiments, can maintain its colloidal properties for a long period of time. Some of the edible food products are beverages, protein and nutritional beverages, mineral fortified beverages, dairy-based beverages, and non-dairy based beverages including, but not limited to, those that are heat treated, for example, by pasteurization, ultra-pasteurization, or retort processes. The typical concentrations of the stabilizer of the present invention used in the above beverage products can range from 0.05% to about 3.5% by wt. of total products, and in some instances 0.2 to 2.0% by wt. of total products.

In particular the compositions of the invention are well suited for stabilization of food and beverages and particular flavored beverages. Accordingly in one embodiment the invention provides a food composition comprising: (i) a colloidal mixture of microcrystalline cellulose and a first alginate; and, (ii) from about 3 to about 20 wt % of a second alginate that is different from the first alginate, wherein the wt % basis of the second alginate is the weight of the solids component of the colloidal mixture.

Where the food is a beverage the beverage may contain: (i) a colloidal mixture of microcrystalline cellulose and a first alginate; and, (ii) from about 3 to about 20 wt % of a second alginate that is different from the first alginate, wherein the wt % basis of the second alginate is the weight of the solids component of the colloidal mixture. Alternatively the beverage or flavored beverage may contain (i) a colloidal mixture of microcrystalline cellulose and a first alginate; and, (ii) from about 3 to about 20 wt % of a second alginate that is different from the first alginate, wherein the wt % basis of the second alginate is the weight of the solids component of the colloidal mixture and wherein component (i) is present in the beverage in an amount of greater than about 0.3 wt % based on the weight of the beverage. Similarly the beverage or flavored beverage may contain (i) a colloidal mixture of microcrystalline cellulose and a first alginate; and, (ii) from about 3 to about 20 wt % of a second alginate that is different from the first alginate, wherein the wt % basis of the second alginate is the weight of the solids component of the colloidal mixture and wherein: (a) the flavored beverage comprises greater than about 0.3 wt % of the colloidal mixture (i) based on the weight of the beverage; and (b) the flavored beverage is stable to significant phase separation and/or substantial viscosity increase over at least a 24-hour observation period. Finally the beverage may comprise a stabilizer composition comprising a first alginate polysaccharide that is different from the second alginate polysaccharide and wherein the second alginate polysaccharide is present in the composition in an amount greater than about 0.0087 wt % based on the weight of the beverage.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions.

### General Methods

Methods for determining the M-block/G-block rations in the relevant alginate species may be obtained from ASTM International, 100 Barr Harbor Drive, PO Box 0700, West Conshohocken, PA 19428-2959. United States, by referring to designation F2259.

The MCC wetcakes used in these Examples were obtained via acid hydrolysis of a prehydrolyzed hardwood pulp (Sulfatate™, available from Rayonier Inc.). The wetcakes were prepared for attrition by mixing aggregated MCC at 43.05 wt % total solids, with a polysaccharide and an acid, as follows:

All ingredients were mixed in a 12-quart bowl on a Hobart A120 mixer (Model No. ML 38904). The wetcake was first loaded in the Hobart mixer bowl. The beater/paddle was then assembled to rotate at lowest setting. Other ingredients such as acids and/or salts were also added to the mixer. The beater/paddle rotation speed was progressively increased to the highest setting until a visually uniform admixture was achieved. This typically took 3-5 minutes. Then, polysaccharides were mixed in for 3-5 minutes in the Hobart mixer bowl. Afterwards, the mixed admixture was fed into a 2″ Readco extruder from Readco Kurimoto, LLC. Three passes were conducted. The extrusion performance was monitored by reading the torque on an attached amperage meter; measuring the temperature of extrudate; and, observing the texture of extrudates. Higher amperage meter readings, hotter extrudate, and firmer extrudate, indicated more effective co-attrition. A simple examination of the extrudates may be performed by measuring the viscosities of the wetcake mixtures slurried in DI-water (deionized water) and by studying dispersion of MCC crystals in the slurries microscopically. Ultimately, the exemplary extrudates were dried into a powder form by slurring in DI-water before being spray dried in a Stork-Bowen 3′ spray drier with an atomizing nozzle, a heating temperature of 225° C., and collecting temperature of 120° C.-130° C.

### UHT (Ultra High Temperature) Flavored Milk Evaluation:

The samples (6 L batch size) were prepared, as follows:
i. A stabilizer sample was dry-blended with cocoa powder and sugar.
ii. The dry-blend was added to milk and mixed at medium shear with a propeller mixer to visually uniform mixture for approximately 30 minutes.
iii. The chocolate milk solution was pre-heated to 185° F. (85° C.) in first-stage pre-heating tubes, then heated to an UHT temperature of 284° F. (140° C.) and held for 6 seconds.
iv. Downstream homogenization was performed at total pressure of 2500 psi (2000 psi and then 500 psi).
v. Chocolate milk was then cooled immediately to <20° C. and filled in a sterile Nalgene bottle in a clean fill hood.
   The samples were evaluated after designated period of time storage under designated conditions. Viscosity and pH were measured, as well as visual observations were made.
   The flavored milk used in the evaluation is chocolate low fat milk with test formulation given in the table below.

TABLE 1
Formulation @ 3.0-3.5 wt % Protein, 1.0-1.5 wt %

| Fat Content | wt % |
|---|---|
| Sugar | 7.5 |
| Cocoa Powder | 0.9 |
| Sample Stabilizer | Various |
| Fresh Milk, 1.0 wt % Fat | Add to 100 |

Colloidal MCC/Manucol DM/Sodium Citrate

MCC wetcake and Manucol DM (from FMC), a product of a low gel strength alginate were co-extruded. Manucol DM has 1 wt % solution viscosity of 150-300 cP at 20° C. with Brookfield LV viscometer at 60 rpm. The ratio of MCC to alginate was 86/14 by solids content. The amount of acid in each sample was 2.5 wt % based on the water content of the MCC wetcake. Three passes of the mixture of the MCC/alginate and acid wetcakes were made through the Readco extruder.

The extrudate was reslurried at 5% total solid in a Waring blender (Model CB15 from Waring Commercial) for 5 minutes and neutralized with a dilute NaOH (4%) solution before spray drying the mixture. The powders thus obtained were the colloidal MCC/Manucol DM with sodium citrate. The stabilizers of the following examples are prepared by dry blending the colloidal MCC/Manucol DM/sodium citrate with the second alginates.

### Example 1

The stabilizer was composed of alginate HV at 12% based on MCC/Manucol DM/sodium citrate. The use level of the stabilizer is 0.35% by wt. of total chocolate low fat milk. The viscosity of 1% alginate HV in di-water is 1040 cP at 20° C. with Brookfield LV viscometer at 60 pm. The M/G ratio is 1.71. Two storage temperatures were set at refrigeration (4° C.) and ambient (˜23° C.). The test results were shown after 42 days of storage.

| | | Refrigeration | Ambient |
|---|---|---|---|
| | Brookfield | 61 | 30 |
| | viscosity (cP) | | |
| | pH | 7.01 | 6.71 |
| Visual | Top phase (mm) | 0 | 0 |
| observation | Bottom phase | 0 | 0 |
| | (mm) | | |
| | Creaming | slight | slight |
| | Top clear | 0 | 0 |
| | separation | | |
| | Marbling | some | none |
| | Bottom clear | 0 | 0 |
| | separation | | |
| | Sedimentation | 0 | 0 |
| | layer | | |
| | Flow properties | 0 | 0 |
| | Flocculation | 0 | 0 |
| | Sedimentation at | 0 | 0 |
| | bottom after | | |
| | pouring | | |
| | Redispersibility | 0 | 0 |

MCC/Manucol DM/sodium citrate plus alginate HV provides adequate stabilization to the chocolate low fat milk.

### Example 2

The stabilizer was composed of alginate LV at 12% based on MCC/Manucol DM/sodium citrate. The use level of the stabilizer is 0.4% by wt. of total chocolate low fat milk. The viscosity of 1% alginate HV in di-water is 248 cP at 20° C. with Brookfield LV viscometer at 60 rpm. The M/G ratio is 1.70. Two storage temperatures were set at refrigeration (4° C.) and ambient (˜23° C.). The test results were shown after 3 months of storage.

| | | Refrigeration | Ambient |
|---|---|---|---|
| | Brookfield | 85 | 52 |
| | viscosity (cP) | | |
| | pH | 6.78 | 6.28 |
| Visual | Top phase (mm) | 0 | 0 |
| observation | Bottom phase | 5.0 | 5.0 |
| | (mm) | | |
| | Creaming | slight | slight |
| | Top clear | 0 | 0 |
| | separation | | |
| | Marbling | slight | none |
| | Bottom clear | 0 | 0 |
| | separation | | |
| | Sedimentation | 0 | 0 |
| | layer | | |
| | Flow properties | 0 | 0 |
| | Flocculation | 0 | 0 |
| | Sedimentation at | 0 | 0 |
| | bottom after | | |
| | pouring | | |
| | Redispersibility | 0 | 0 |

The MCC/Manucol DM/sodium citrate plus alginate LV provides adequate stabilization to the chocolate low fat milk.

### Example 3

The stabilizer was composed of alginate HV/alginate LV=50%/50% at 12% of total alginate HV and alginate LV based on MCC/Manucol DM/sodium citrate. The use level of the stabilizer is 0.4% by wt. of total chocolate low fat milk. Two storage temperatures were set at refrigeration (4° C.) and ambient (˜23° C.). The test results were shown after 42 days of storage.

| | | Refrigeration | Ambient |
|---|---|---|---|
| | Brookfield | 82 | 43 |
| | viscosity (cP) | | |
| | pH | 6.96 | 6.68 |
| Visual | Top phase (mm) | 0 | 0 |
| observation | Bottom phase | 2.0 | 0 |
| | (mm) | | |
| | Creaming | slight | slight |
| | Top clear | 0 | 0 |
| | separation | | |
| | Marbling | slight | none |
| | Bottom clear | 0 | 0 |
| | separation | | |
| | Sedimentation | 0 | 0 |
| | layer | | |
| | Flow properties | 0 | 0 |
| | Flocculation | 0 | 0 |
| | Sedimentation at | 0 | 0 |
| | bottom after | | |
| | pouring | | |
| | Redispersibility | 0 | 0 |

The MCC/Manucol DM/sodium citrate plus alginate HV and alginate LV provides adequate stabilization to the chocolate low fat milk.

### Example 4

The stabilizer was composed of Manucol DM and alginate HV at the equivalent concentration of the stabilizer in Example 1. The difference of the stabilizers in Example 1 and Example 4 is no MCC in the stabilizer in Example 4. The use level of the stabilizer is 0.084% by wt. of total chocolate low fat milk, due to removal of MCC. Otherwise, the use level would be 0.35% by wt. of total chocolate low fat milk. Three storage temperatures were set at refrigeration (4° C.), ambient (˜23° C.) and 30° C. The test results were shown after seven days of storage.

| | | Refrigeration | Ambient | 30° C. |
|---|---|---|---|---|
| | Brookfield | 12 | 8.5 | 6 |
| | viscosity (cP) | | | |
| | pH | 6.8 | 6.6 | 6.6 |
| Visual | Top phase (mm) | 0 | 0 | 0 |
| observation | Bottom phase (mm) | 0 | 0 | 0 |
| | Creaming | none | none | slight |
| | Top clear | 0 | 0 | 0 |
| | separation | | | |
| | Marbling | none | none | none |
| | Bottom clear | 0 | 0 | 0 |
| | separation | | | |
| | Sedimentation | Severe | Severe | Severe |
| | layer | | | |
| | Flow properties | 0 | 0 | 0 |
| | Flocculation | 0 | 0 | 0 |
| | Sedimentation at | Very strong | Very strong | Very strong |
| | bottom after | sedimentation | sedimentation | sedimentation |
| | pouring | | | |
| | Redispersibility | Sedimentation | Sedimentation | Sedimentation |
| | | disappears after | disappears after | disappears after |
| | | four times | four times | four times |
| | | pouring | pouring | pouring |

Severe precipitation of cocoa particles was noticed. The observation affirms the stabilization functionality of colloidal MCC/Manucol DM/sodium citrate plus alginate HV.

### Example 5

The stabilizer was composed of alginate GP at 8% based on MCC/Manucol DM/sodium citrate. The viscosity of 1% alginate GP in di-water is 196 cP at 20° C. with Brookfield LV viscometer at 60 rpm. The M/G ratio is 0.97. The use level of the stabilizer is 0.4% by wt. of total chocolate low fat milk. Two storage temperatures were set at refrigeration (4° C.) and ambient (˜23° C.). The test results were shown after 28 days of storage.

| | | Refrigeration | Ambient |
|---|---|---|---|
| | Brookfield | 37 | 24 |
| | viscosity (cP) | | |
| | pH | 7.0 | 6.8 |
| Visual | Top phase (mm) | 28 | 10 |
| observation | Bottom phase | 0 | 0 |
| | (mm) | | |
| | Creaming | none | slight |
| | Top clear | 0 | 0 |
| | separation | | |
| | Marbling | severe | none |
| | Bottom clear | 0 | 0 |
| | separation | | |
| | Sedimentation | 0 | 0 |
| | layer | | |
| | Flow properties | 0 | 0 |
| | Flocculation | 0 | 0 |
| | Sedimentation at | 0 | 0 |
| | bottom after | | |
| | pouring | | |
| | Redispersibility | 0 | 0 |

Significant top phase separation was observed, indicating poor stabilization from the stabilizer.

### Example 6

The stabilizer was composed of alginate GH at 17% based on MCC/Manucol DM/sodium citrate. The viscosity of 1% alginate GH in di-water is 58 cP at 20° C. with Brookfield LV viscometer at 60 rpm. The M/G ratio is 0.56. The use level of the stabilizer is 0.35% by wt. of total chocolate low fat milk. Three storage temperatures were set at refrigeration (4° C.), ambient (˜23° C.) and 30° C. The test results were shown after 3 months of storage.

| | | Refrigeration | Ambient | 30° C. |
|---|---|---|---|---|
| | Brookfield | 35 | 23.5 | 20.5 |
| | viscosity (cP) | | | |
| | pH | 6.9 | 6.8 | 6.6 |
| Visual | Top phase (mm) | 45 | 30 | 30 |
| observation | Bottom phase (mm) | 0 | 0 | 0 |
| | Creaming | Slight | Some | Some |
| | Top clear | 0 | 0 | 0 |
| | separation | | | |
| | Marbling | Moderate | None | None |
| | Bottom clear | 0 | 0 | 0 |
| | separation | | | |
| | Sedimentation | 0 | 0 | 0 |
| | layer | | | |
| | Flow properties | 0 | 0 | 0 |
| | Flocculation | 0 | 0 | 0 |
| | Sedimentation at | Very slight | Very slight | Very slight |
| | bottom after | | | |
| | pouring | | | |
| | Redispersibility | Sedimentation | Sedimentation | Sedimentation |
| | | disappears after | disappears after | disappears after |
| | | two times | two times | two times |
| | | pouring | pouring | pouring |

Alginate GH has significantly lower 1% solution viscosity than other alginates in the examples. In several separate bench-top chocolate low fat milk tests increase of alginate GH from 8% to 17% in the wet blending makes comparable viscosity of UHT chocolate low fat milk to other examples in the invention. Inadequate stabilization was noticed by significant top phase separation.

### Example 7

The stabilizer was composed of alginate MC at 8% based on MCC/Manucol DM/sodium citrate. The viscosity of 1% alginate MC in di-water is 442 cP at 20° C. with Brookfield LV viscometer at 60 rpm. The M/G ratio is 0.89. The use level of the stabilizer is 0.4% by wt. of total chocolate low fat milk. Two storage temperatures were set at refrigeration (4° C.) and ambient (˜23° C.). The test results were shown after 2 weeks of storage.

| | | Refrigeration | Ambient |
|---|---|---|---|
| | Brookfield | 43.5 | 24.5 |
| | viscosity (cP) | | |
| | pH | 6.69 | 6.8 |
| Visual | Top phase (mm) | 5.0 | 10 |
| observation | Bottom phase | 0 | 0 |
| | (mm) | | |
| | Creaming | slight | slight |
| | Top clear | 0 | 0 |
| | separation | | |
| | Marbling | severe | none |
| | Bottom clear | 0 | 0 |
| | separation | | |
| | Sedimentation | 0 | 0 |
| | layer | | |
| | Flow properties | 0 | 0 |
| | Flocculation | 0 | 0 |
| | Sedimentation at | 0 | 0 |
| | bottom after | | |
| | pouring | | |
| | Redispersibility | 0 | 0 |

Top phase separation was noticed, indicating poor stabilization from the stabilizer.

### Example 8

The stabilizer was composed of alginate LJ at 12% based on MCC/Manucol DM/sodium citrate. The viscosity of 1% alginate LJ in di-water is 520 cP at 20° C. with Brookfield LV viscometer at 60 rpm. The M/G ratio is 1.26. The use level of the stabilizer is 0.4% by wt. of total chocolate low fat milk. Two storage temperatures were set at refrigeration (4° C.) and ambient (˜23° C.). The test results were shown after 1 month of storage.

| | | Refrigeration | Ambient |
|---|---|---|---|
| | Brookfield | 78.5 | 42.0 |
| | viscosity (cP) | | |
| | pH | 6.9 | 6.7 |
| Visual | Top phase (mm) | 0.0 | 0.0 |
| observation | Bottom phase | 7.0 | 0 |
| | (mm) | | |
| | Creaming | slight | slight |
| | Top clear | 0 | 0 |
| | separation | | |
| | Marbling | none | none |
| | Bottom clear | 0 | 0 |
| | separation | | |
| | Sedimentation | 0 | 0 |
| | layer | | |
| | Flow properties | 0 | 0 |
| | Flocculation | 0 | 0 |
| | Sedimentation at | 0 | 0 |
| | bottom after | | |
| | pouring | | |
| | Redispersibility | 0 | 0 |

Overall, the stabilizer provided a suitable stabilization to the chocolate low fat milk, with some bottom phase noticed to the stabilized chocolate milk.

### Comparative Examples

MCC/Manucol DM=85/15 with 4% Citric Acid Made Through Readco Extruder

A combination of MCC/Manucol DM at 0.35% and gellan HA at 250 ppm was evaluated as a stabilizer in UHT low fat chocolate milk. After three months under refrigeration and ambient storage, there was no observation of cocoa sedimentation or gelation. As a comparison, with only 250 ppm gellan HA, there was observed low levels of dusting and no gelation of milk.

A combination of MCC/Manucol DM at 0.5% and gellan HA at 150 ppm as a stabilizer was also evaluated in UHT low fat chocolate milk. After three months in refrigeration and in ambient storages, there was no sedimentation and no gelation of milk. Only low levels of dusting were observed at the bottom of bottle in the ambient storage milk. As a comparison, heavy sedimentation layers were apparent in the chocolate milk stabilized with only 150 ppm gellan HA in both refrigeration and ambient storage.

1. A stabilizer composition comprising:
(i) microcrystalline cellulose;
(ii) a first polysaccharide; and
(iii) a second polysaccharide;
Wherein the microcrystalline cellulose and the first polysaccharide form a colloidal mixture; and
Wherein the second polysaccharide is present in a concentration of from about 3 to about 20 wt % based on the solid weight of the colloidal mixture of the microcrystalline cellulose and the first polysaccharide.

2. The stabilizer composition of claim 1 further comprising an attrition agent.

3. The stabilizer composition of claim 2 wherein the attrition agent is an acid.

4. The stabilizer of claim 3 wherein the acid is selected from the group consisting of formic acid, acetic acid, propionic acid, butyric acid, valeric acid, caproic acid, oxalic acid, lactic acid, malic acid, citric acid, tartaric acid, benzoic acid, carbonic acid, hydrochloric acid, nitric acid, phosphoric acid, sulfuric acid, boric acid, hydrofluoric acid, and hydrobromic acid.

5. The stabilizer composition of claim 1 wherein the first and second polysaccharides are different.

6. The stabilizer composition of claim 1 wherein the first and second polysaccharides are the same.

7. The stabilizer composition of claim 1 wherein either one or both of the first and second polysaccharide includes acidic sugar residues.

8. The stabilizer composition of claim 7 wherein at least the first polysaccharide comprises a main polymer chain containing the acidic sugar residues.

9. The stabilizer composition of claim 8 wherein the acid residues are selected from the group consisting of at least one of galacturonic acid, glucuronic acid, mannuronic acid and guluronic acid.

10. The stabilizer composition of claim 1 wherein either one or both of the first and second polysaccharide is derived from plant exudates; plant seeds, plant roots; seaweed polysaccharides, microbial and fermentation products and combinations thereof.

11. The stabilizer composition of claim 2 wherein either one or both of the first and second polysaccharide is alginate.

12. The stabilizer composition of claim 11 wherein the alginate comprises at least 50% mannuronic acid residues.

13. The stabilizer composition of claim 12 wherein the alginate comprises less than about 50% guluronic acid residues.

14. The stabilizer composition of claim 13 wherein the ratio of mannuronic acid residues to guluronic acid residues is greater than about 1:1.

15. The stabilizer composition of claim 11 wherein the total alginate present in the stabilizer composition is from about 9 to about 68 wt %, based on the weight of the stabilizer.

16. The stabilizer composition of claim 11 wherein the first polysaccharide is alginate and comprises from about 8-50 wt % of the colloidal mixture.

17. The stabilizer composition of claim 1 wherein the D₅₀ of at least 19% by volume of the MCC particles is about 0.110 microns.

18. The stabilizer composition of claim 1 wherein the composition is substantially devoid of multivalent ions.

19. A process for the production of a stabilizer composition comprising microcrystalline cellulose and a first and second polysaccharide comprising the steps of:
a) co-attriting microcrystalline cellulose with a first polysaccharide to obtain a colloidal co-attrited mixture of MCC and the first polysaccharide; and
b) blending the colloidal mixture of step (a) with a second polysaccharide wherein the second polysaccharide comprises from about 3 to about 20 wt % of the colloidal mixture obtained in step (a).

20-25. (canceled)

26. A consumable product comprising the stabilizer composition of claim 1.

27-31. (canceled)
